(19) United States
(12) Patent Application Publication
(10) Pub. No.: US 2006/0284729 A1
(43) Pub. Date: Dec. 21, 2006

(54) Pro monitoring

(76) Inventor: Derwand Derome Shorter, Memphis, TN (US)

Correspondence Address: Derwand Shorter, 4073 Royal Crest Dr., Memphis, TN, 38115, US

(21) Appl. No.: 11/155,185

(22) Filed: Jun. 20, 2005

(51) Int. Cl. B60R 25/10

(52) U.S. Cl. 340/426.1

(57) ABSTRACT

I Derwand Shorter declare that I'm the inventor of the very first security system for trucks and trailers, (18-wheeler.) I'm a truck driver of 8 years, and my father is a driver of 30 years, therefore, due to our experience with 18-wheelers, neither of us has ever seen or head of a security system for 18-wheelers. However, I do know about car security systems but I don't think a car security system has the ability to perform in a truck and definitely not in a trailer. There are also home security systems, which are not suitable for securing an 18-wheeler. I must say that I have done no research to be sure that a security system for a truck and trailer has not been invented.

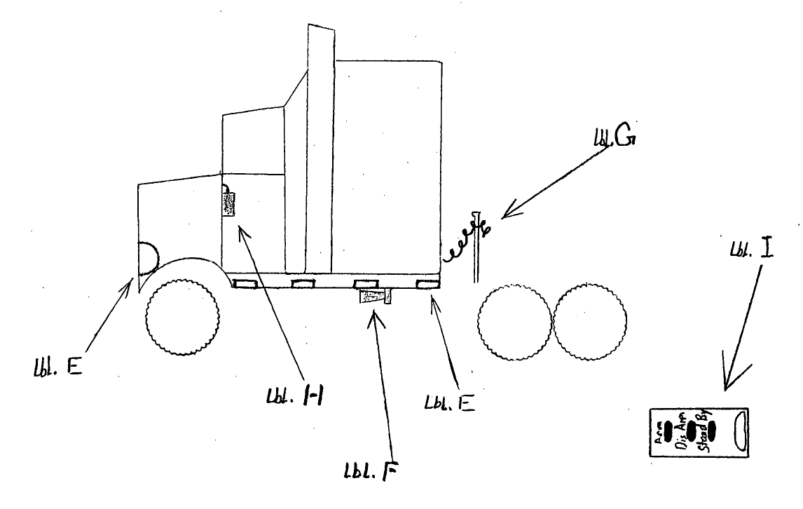

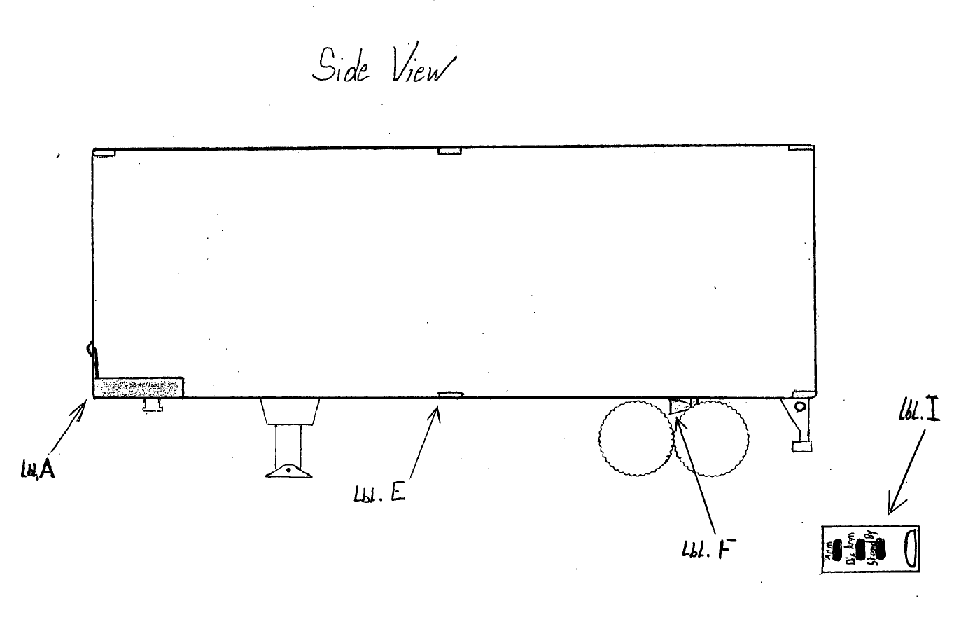

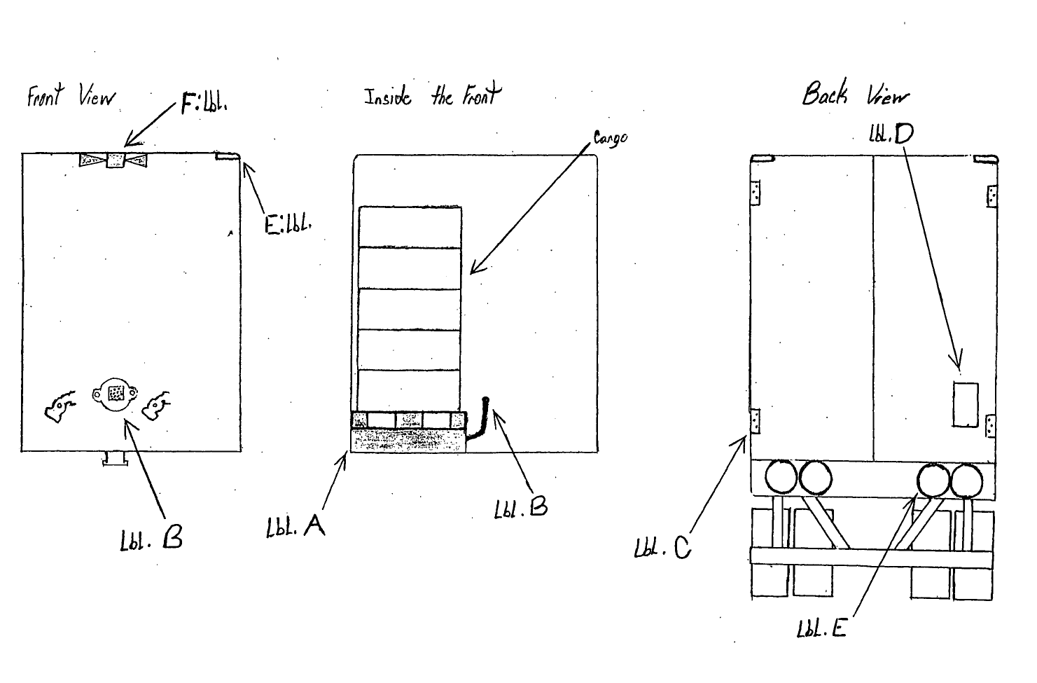

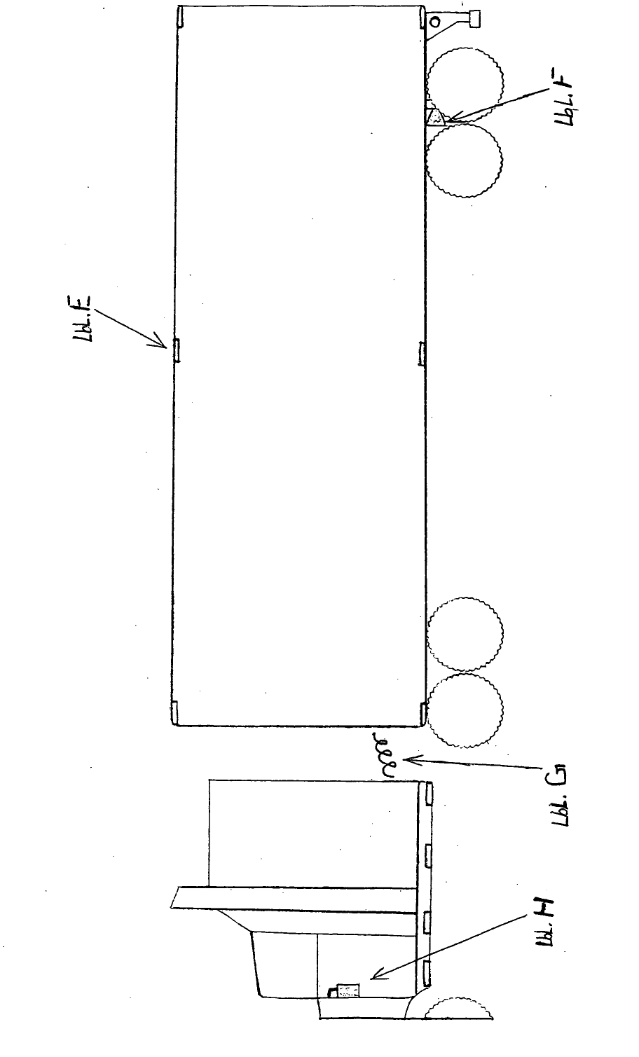

### BACKGROUND OF INVENTION

To my knowledge, there is only one method of security for a truck and trailer, which are many types of locks. There is also a highway tracking master system, which is only for knowing the location of a truck and trailer. The Pro Monitoring security system is designed to provide a sense of security for the trucking industry. To my knowledge, there has been no security system made specifically for trucks and trailers.

### BRIEF SUMMARY

The Pro Monitoring Security has many advantages, most are very important to the trucking industry. Surely, thief and burglary has been among the inevitable for the trucking industry. With my invention of the Pro Monitoring Security System, a truck and its trailer will be secure, just as a person would secure their car and home. A truck are responsible for delivering thousands of dollars in merchandise to places all over the world, and is at least an 80 thousand dollars a piece of equipment in itself. This security system will prevent thief and burglary of these vehicles and the contents, which they transport.

The security system will indicate to any person near by that a burglary or thief is taking place, when the security system is connected to the GPS system for more accurate monitoring. The location of the vehicle is known and if a burglary takes place that is known also. By knowing the vehicle's location law enforcement in the area, can be notified when a burglary is taking place. This security system will be very useful for truckers because trucks are so big they normally are prevented from parking in public areas, which leave only remote areas.

### BRIEF DESCRIPTION OF THE DRAWINGS

Diagram: Pages 2 and 3

Label A: Trailers Brain Box and Power Supply

The trailers brain box and power supply will be location in the far front of the trailer, either on the floor, “which is shown in the diagram on page 3,” are standing up against the front wall which is not shown. The location of the brain and the power supply will be placed in either position that comforts the owner. Never the less, cargo acts as a defense for the brain and power supply, when the trailer has a load on. The security system for the trailer will have the ability to recognize a tractor's security system's presence, if the tractor and trailer are dedicated from each other, in this case, only one remote control can be used to arm and disarm both systems. Systems that do not recognize each other will be separated remote controls. When the trailer's security system, has to defend, it will have an eight minutes automatic reset time. Also, dedicate tractor and trailers armed together will guard together, even if an intruder both systems will defend tampers with one.

Diagram Page 3

Label B: Main Trailer Wiring

The trailer brain will be wired directly into the trailer's pig tail harness to the trailer's lights. This pigtail harness is located on the front of the trailer, which allows a tractor to apply normal control and power to the lights on the trailer. By wiring directly into the pig trail harness, when a tractor's pig tail is supplying normal control and power to the trailers lights the tractor can also send a charge to the power supply of the security system if needed. By wiring directly into pit tail harness makes disabling difficult.

Diagram Page 3

Label C: Trailer Door Security

The door will be equipped with a sensor that will trigger the defense mode of the trailer's security system if the first trailer is opened, “at all,” while the security system is armed. The security system will defend until it is rest. One door will be equipped with a sensor, regardless, whether the other door is armed or not it is optional.

Diagram Page 3

Label D: Trailer Vent Door

The vent door will be equipped with a sensor that acts in the same manner as the Label C door security sensor. If the vent door is opened at anytime while security system is armed the security system will defend until the system is reset. The vent door sensor is optional and strongly suggested! A vent door allows easy visible access to inside the trailer.

Diagram Pages 1, 2, 3 and 4

Label E: Means of Defense #1

Every light on each vehicle will act as a defense by blinking when security system is in its defending mode. This defense will continue until security system is reset, disabling every light on either vehicle will be very difficult. Attempting to move a vehicle with no lights is noticeable.

Diagram Pages 1, 2, 3, and 4

Label F: Means of Defense #2

The siren is a defense device. This siren may be mounted in a place that comforts the owner. The siren will connect to the brain box for functioning purposes. When the defense mode is triggered, the siren will sound of until the security system is reset.

Diagram Page 1

Label G: Necessary Charge for Trailer

The tractor's pig tall will offer a charge to the trailer's security system power supply to ensure the security systems ability to perform. Also, if the trailer is armed, any pig tall that attempts to connect or disconnect will activate the trailers security system's defense mode. Defending will continue until security system is reset.

Diagram Pages 1, and 4

Label H: Tractor's Security System Brain Box

The tractor's brain box will be installed inside the cab of the truck wherever agreed upon by the owner. The tractor's brain box will operate on the tractor's power supply and will be wired directly to the light wiring in the tractor's dash. If a tractor is dedicate to a trailer, then the tractor's security system recognize each other and are able to function on only the one remote control to arm and disarm both security systems. When arming just one security system, the tractor ignition must be on which make its security system useless, and then the trailer can only be armed with the remote control. The tractor'security system will be an automatic arming ability. When the tractor's security system will equip both tractor doors with sensors, that will activate security systems defense mode if either door is open while system is armed, more senses are optional.

Diagram Pages 1 and 2

Label 1: Tractor and Trailer Remote Control

The tractor and trailer security system remote control is used to arm and disarm both security systems. In some cases separate remote controls will be required for each security system. Each remote control will consist of three buttons. One button to arm the security system, the second button to disarm the security system, and a third button to activate the security system's stand by mode on a tractor's security system. The security system remote control will simply fit on a key ring.

### DETAILED DESCRIPTION OF THE INVENTION

Trailer

Pro monitoring system for the trailer is not a very complicated design. Processing this security will be some what simple. The electrical device will be made from heavy but electrical parts that are able to handle power that is necessary to operate the lighting effects when the security system is defending. This particular electrical system will have the ability to receive a signal from remote device or access keypad for arming and disarming. Also, this electrical device will have an automatic resetting time limit to reset the defense mode, after arming, if the system is not reset by the remote control. The security system will allow this charge if necessary from the power supplied from a tractor, when the tractor is connected to the trailer, and is not armed. Pro Monitoring security system will be powered by batteries as many as three but are not necessarily three, (batteries are not included.)

How many batteries are used will depend on the number of lights a trailer has to defend with. This electrical security system for the trailer can be connected to a GPS System, and then a trailer can have more accurate monitoring from anywhere in the US. The casing for the electronics will be made out of plastic, basically a plastic box. The power supply and electrical box will be placed inside a wooden casing, made just for the contents. The wooden casing will be made to support at least 500 pounds. The size will be the same as two cargo pallets stacked together being able to support weight. This wooden casing allows a pallet of cargo to be placed on top of the security system, so that cargo space is not lost and access to the system is difficult.

The Pro Monitoring Security System consists of installing, which is not very complicated. Simply mount the wooden casing that contains the security system inside the trailer in the far front left or right side of the trailer floor main wiring or the outside wiring to the lights that require drilling a hole, wiring into the pig tail receptacle, wiring sensors to the doors and other parts which are desired to be monitored, will consist of running the wires pass the hole up to the top of the trailer in the inside part, approximately 65 inch of wire.

### DETAILED DESCRIPTION OF INVENTION

Truck

Pro Monitoring Security System for the tractor trailer will be a electrical device that's made of heavy duty electrical parts so over heating won't be a problem. The electrical device will have the ability to receive a signal from a remote control for arming, disarming and stand by mode. The security system will come with five sensors that are for monitoring the two doors on the cab of the truck, and what ever desire to be monitored.

The Pro Monitoring Security System will have the ability to apply necessary power to the lights of the tractor when defending occurs. The electrical device will also power a siren, which is a part of the defense of the security system, when defending that electrical security system it will have an automatic reset time limit for resetting the defense mode. If it is not reset by the remote control, this security system will receive any needed operating power from the tractor's power supply. The casing for the electrical device will be strong plastic casing specially made for the security device. That data watch security system will have the ability to connect to a GPS System for more accurate monitoring from anywhere in the United States.

Using this security system requires installing this electrical system inside a truck. Installation consists of wiring the security system to the light wiring inside the trucks cab, and running the two sensors to each door and other sensors where ever desired. Also, mounting the siren will be placed wherever desired. The actual arming and disarming of this security system is simply pressing a button to arm this system and the pressing of a separate button to disarm the system, also there would be another button for the stand by mode. These buttons will be located on a hand held remote control or an access key pad.

1. What I claim as my invention is a security system for a trailer. The security system will power as many as 60 lights which include six tail lights and fifty four marker lights. This security system will also operate a siren and five sensors for monitoring desired parts of the trailer.
My security system for a trailer will have a database for collecting information and delivering gathered information to a GPS System or any other type of satellite monitoring system if desired. This security system will rely on nothing more than 12 volts of power for operating. If the voltage of power supply needs to be restored the security system has the ability to offer a charge to the power supply when a truck applies power for the trailer. (Note: the power supply for this system is batteries that are not included.)
